(19) United States
(12) Patent Application Publication
(10) Pub. No.: US 2026/0135718 A1
(43) Pub. Date: May 14, 2026

(54) ARTIFICIAL INTELLIGENCE SUPPLY CHAIN INTEGRITY AND PROVENANCE SYSTEM

(71) Applicant: George William Bickerstaff, III, Greenwich, CT (US)

(72) Inventor: George William Bickerstaff, III, Greenwich, CT (US)

(21) Appl. No.: 19/443,914

(22) Filed: Jan. 8, 2026

(51) Int. Cl. H04L 9/32

(52) U.S. Cl. CPC H04L 9/3268

(57) ABSTRACT

An artificial intelligence supply chain integrity and provenance system is disclosed that continuously verifies origin, lineage, and integrity of artificial intelligence supply chain components across data assets, model artifacts, execution environments, and inference pathways. The system detects unauthorized modification in near real time and generates machine-verifiable certification artifacts, enabling automated trust, governance, and audit of complex artificial intelligence systems.

### TECHNICAL FIELD

The present invention relates to artificial intelligence systems and, more particularly, to technical systems and methods for verifying integrity, provenance, and authenticity across artificial intelligence supply chains, including data assets, model artifacts, execution environments, and inference outputs.

### BACKGROUND

Artificial intelligence systems increasingly rely on distributed and multi-party supply chains involving training datasets, preprocessing pipelines, model versions, execution environments, and third-party software components. These supply chains often span organizational, infrastructural, and jurisdictional boundaries, creating expanded attack surfaces and integrity risks.

Existing artificial intelligence security approaches rely primarily on perimeter defenses, access controls, and static certifications, which are insufficient to ensure integrity across dynamic and evolving artificial intelligence supply chains. Unauthorized modification of training data, model parameters, execution environments, or inference pathways may result in degraded performance, biased outputs, regulatory non-compliance, or malicious behavior. Manual audits and point-in-time certifications are unable to provide continuous, machine-verifiable assurance in such environments.

Accordingly, there exists a technical need for a system that continuously verifies provenance and integrity of artificial intelligence supply chain components during training, deployment, execution, and inference, and that produces machine-verifiable integrity artifacts suitable for automated assurance and audit.

### SUMMARY OF THE INVENTION

The invention provides an artificial intelligence supply chain integrity and provenance system configured to continuously verify the origin, lineage, and integrity of artificial intelligence supply chain components, including data assets, model artifacts, execution environments, and inference outputs.

The system captures structured provenance records, establishes integrity baselines, validates runtime behavior through cryptographic and behavioral verification mechanisms, detects unauthorized modification in near real time, and generates machine-verifiable certification artifacts. By embedding integrity verification directly into artificial intelligence workflows, the invention improves system trustworthiness, enables automated governance, and reduces risk associated with distributed artificial intelligence supply chains.

### DEFINITIONS

### Certification Artifact

A machine-generated, cryptographically verifiable data structure attesting to integrity, provenance, and validation status of one or more artificial intelligence supply chain components.

### Execution Environment

A hardware and/or software context in which an artificial intelligence model is trained, deployed, or executed, including runtime configurations and dependencies subject to integrity verification.

### Inference Path

A sequence of computational operations executed to produce an inference output, wherein the sequence is monitored and validated against an expected execution pattern.

### Integrity Event

A detected deviation between an observed state of an artificial intelligence supply chain component and an expected integrity baseline.

### Model Provenance

Structured metadata describing origin, version lineage, and historical relationships of an artificial intelligence model.

### Provenance Record

A structured, time-stamped record capturing origin, transformation history, and lineage of an artificial intelligence supply chain component.

### Supply Chain Component

Any data asset, model artifact, execution environment element, or system module contributing to training, deployment, or operation of an artificial intelligence system.

### Tamper Detection Signal

A machine-detectable indicator generated in response to unauthorized modification or deviation from an expected integrity baseline.

### Trust Verification Engine

A system component configured to perform automated integrity validation of artificial intelligence supply chain components during runtime or lifecycle operations.

### Version Lineage

A chronological linkage of successive versions of an artificial intelligence supply chain component enabling traceability and rollback.

### BRIEF DESCRIPTION OF THE DRAWINGS

FIG. 1 illustrates model provenance tracking.

FIG. 2 illustrates training data lineage verification.

FIG. 3 illustrates inference path validation.

FIG. 4 illustrates tamper detection and response.

FIG. 5 illustrates certification and audit outputs.

### DETAILED DESCRIPTION OF THE INVENTION

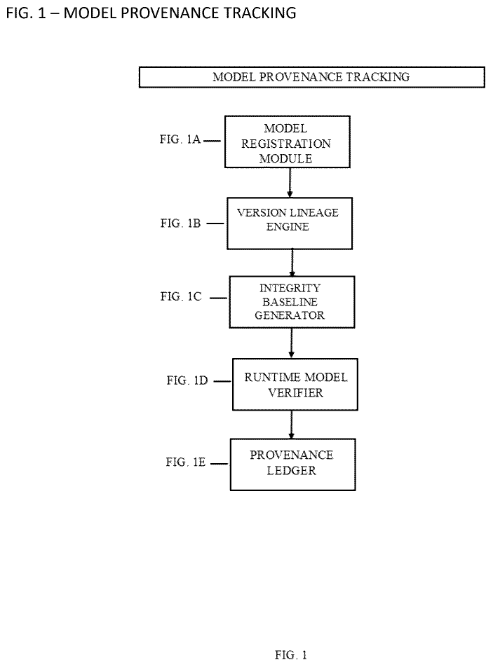

### FIG. 1—Model Provenance Tracking

### FIG. 1A—Model Registration Module

Artificial intelligence models are registered prior to deployment. Registration captures model provenance metadata including origin, ownership, and version lineage. Metadata is cryptographically secured.

### FIG. 1B—Version Lineage Engine

Successive model versions are linked into a chronological lineage. Each version references a predecessor state, enabling traceability and rollback.

### FIG. 1C—Integrity Baseline Generator

Integrity baselines are generated for registered models. Baselines may include cryptographic hashes and behavioral characteristics and are securely stored.

### FIG. 1D—Runtime Model Verifier

Deployed models are continuously validated against established integrity baselines during execution. Deviations are detected in near real time.

### FIG. 1E—Provenance Ledger

Provenance records are stored in a cryptographically protected, append-only ledger providing tamper-evident auditability.

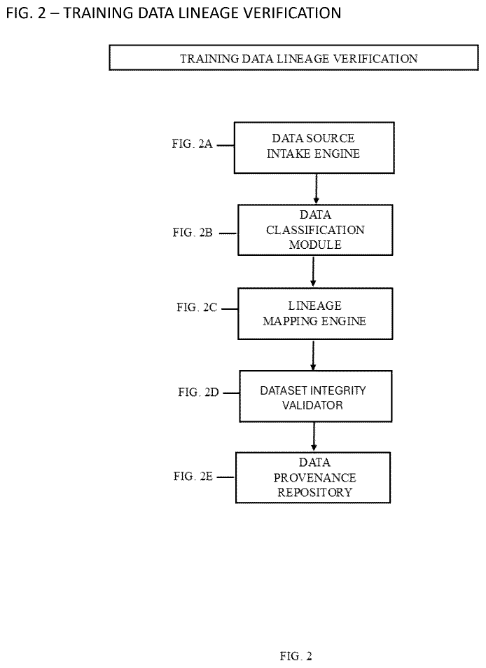

### FIG. 2—Training Data Lineage Verification

### FIG. 2A—Data Source Intake Engine

Training data sources are ingested with associated provenance metadata. Source authentication events are recorded.

### FIG. 2B—Data Classification Module

Data assets are automatically classified by sensitivity and jurisdictional attributes to inform handling and retention.

### FIG. 2C—Lineage Mapping Engine

Transformations applied to data assets are recorded, preserving derivation history and causal relationships.

### FIG. 2D—Dataset Integrity Validator

Datasets are validated against expected integrity characteristics before and after training operations.

### FIG. 2E—Data Provenance Repository

Provenance records for data assets are securely stored and retained for audit and verification.

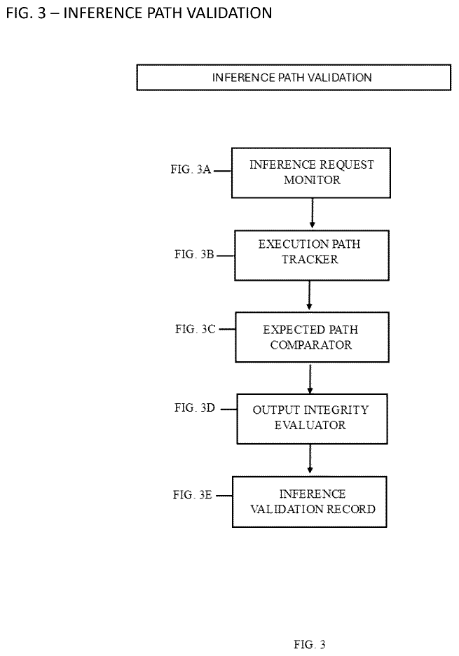

### FIG. 3—Inference Path Validation

### FIG. 3A—Inference Request Monitor

Inference requests are monitored at runtime with associated contextual metadata.

### FIG. 3B—Execution Path Tracker

Computational steps executed during inference are tracked and ordered.

### FIG. 3C—Expected Path Comparator

Observed inference paths are compared against expected execution patterns to detect deviations.

### FIG. 3D—Output Integrity Evaluator

Inference outputs are evaluated for integrity consistency, including statistical validation where applicable.

### FIG. 3E—Inference Validation Record

Validation outcomes are recorded and retained for audit.

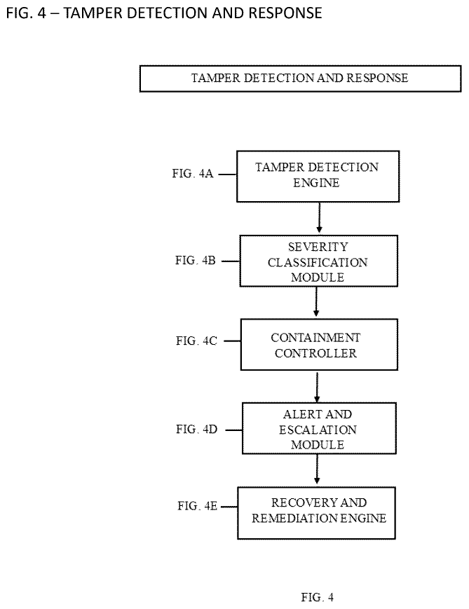

### FIG. 4—Tamper Detection and Response

### FIG. 4A—Tamper Detection Engine

Integrity events are detected based on deviations identified through cryptographic or behavioral mechanisms.

### FIG. 4B—Severity Classification Module

Detected integrity events are classified according to impact severity.

### FIG. 4C—Containment Controller

Affected supply chain components are isolated, halted, or rerouted to prevent further propagation.

### FIG. 4D—Alert and Escalation Module

Alerts with supporting evidence are generated and escalated to designated stakeholders.

### FIG. 4E—Recovery and Remediation Engine

Verified component states are restored using version lineage information and validated baselines.

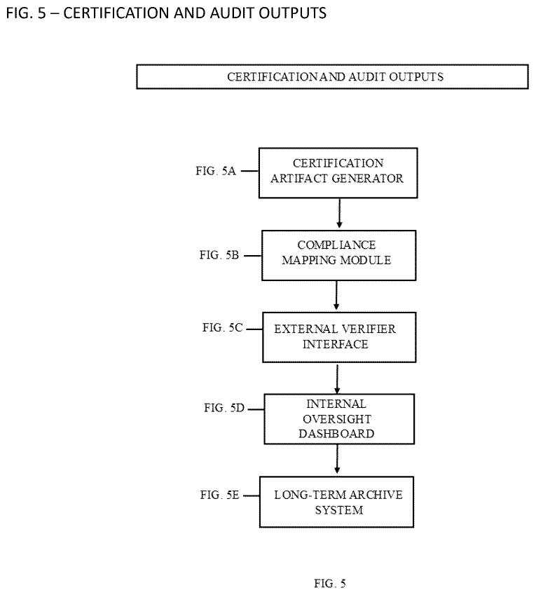

### FIG. 5—Certification and Audit Outputs

### FIG. 5A—Certification Artifact Generator

Certification artifacts are generated attesting to verified integrity and provenance.

### FIG. 5B—Compliance Mapping Module

Certification artifacts are mapped to regulatory or contractual verification requirements.

### FIG. 5C—External Verifier Interface

Secure interfaces expose certification artifacts to authorized external verifiers.

### FIG. 5D—Internal Oversight Dashboard

Integrity status and risk indicators are presented to system operators.

### FIG. 5E—Long-Term Archive System

Artifacts and logs are securely archived with integrity preservation.

### Illustrative Operational Example (non-Limiting)

In one non-limiting example, training datasets are ingested and registered with associated provenance records and integrity baselines. A model trained using the datasets is registered with captured model provenance and version lineage.

During deployment, the runtime model verifier validates the model within an execution environment. An inference request triggers execution path tracking and comparison against an expected inference path. A detected deviation generates a tamper detection signal classified as an integrity event, resulting in automated containment.

A verified prior model version is restored using stored version lineage. Following successful validation, a certification artifact is generated and archived for audit or external verification.

1. An artificial intelligence supply chain integrity system, comprising:
a provenance tracking module configured to record origin and version lineage of artificial intelligence supply chain components including data assets, model artifacts, and execution environment elements;
a trust verification engine configured to validate integrity of the artificial intelligence supply chain components during runtime by comparing observed states to stored integrity baselines; and
a tamper detection module configured to detect unauthorized modification of the artificial intelligence supply chain components and generate a tamper detection signal indicative of an integrity event.

2. A method for verifying integrity of an artificial intelligence system, comprising:
recording provenance records associated with artificial intelligence supply chain components;
establishing integrity baselines for the artificial intelligence supply chain components;
monitoring execution environments and inference paths during runtime operation; and
detecting deviations between observed states and expected integrity baselines indicative of tampering.

3. A non-transitory computer-readable medium storing instructions that, when executed by one or more processors, cause a system to:
record provenance and version lineage of artificial intelligence supply chain components;
validate integrity of the artificial intelligence supply chain components during runtime operation;
detect integrity events based on deviations from expected integrity baselines; and
generate machine-verifiable certification artifacts attesting to integrity and provenance of the artificial intelligence supply chain components.

4. The system of claim 1, wherein the provenance tracking module stores provenance records in a cryptographically protected, append-only ledger.

5. The system of claim 1, wherein the trust verification engine validates integrity by monitoring inference paths and comparing observed execution sequences to expected execution patterns.

6. The system of claim 1, wherein detection of an integrity event triggers automated containment of at least one affected artificial intelligence supply chain component.

7. The method of claim 2, wherein recording provenance records includes capturing transformation history and version lineage of training data assets.

8. The method of claim 2, wherein detecting deviations further comprises classifying integrity events according to severity.

9. The computer-readable medium of claim 3, wherein execution of the instructions causes automated restoration of a verified prior component version using stored version lineage.

10. The computer-readable medium of claim 3, wherein the certification artifacts are archived in a tamper-evident manner for audit or external verification.
